(19) United States
(12) Patent Application Publication
(10) Pub. No.: US 2021/0012520 A1
(43) Pub. Date: Jan. 14, 2021

(54) DISTANCE MEASURING METHOD AND DEVICE

(71) Applicant: SZ DJI TECHNOLOGY CO., LTD., Shenzhen (CN)

(72) Inventors: You ZHOU, Shenzhen (CN); Jie LIU, Shenzhen (CN); Jiaqi YAN, Shenzhen (CN)

(21) Appl. No.: 17/033,872

(22) Filed: Sep. 27, 2020

Related U.S. Application Data
(63) Continuation of application No. PCT/CN2018/101510, filed on Aug. 21, 2018.

(51) Int. Cl. G06T 7/579; G01C 19/00; G01P 15/00; B64C 39/02; B64D 47/08; G06T 7/73; H04N 5/232

(52) U.S. Cl. CPC G06T 7/579; G01C 19/00; G01P 15/00; B64C 39/024; B64D 47/08; G06T 7/74; G06T 2207/30244; B64C 2201/027; B64C 2201/127; G06T 2207/10032; G06T 2200/24; G06T 2207/20104; G06T 2207/20084; H04N 5/23299

(57) ABSTRACT

A method for measuring distance using an unmanned aerial vehicle (UAV) includes: identifying a target object to be measured; receiving a plurality of images captured by a camera of the UAV when the UAV is moving and the camera is tracking the target object; collecting movement information of the UAV corresponding to capturing moments of the plurality of images; and calculating a distance between the target object and the UAV based on the movement information and the plurality of images.

### CROSS-REFERENCE TO RELATED APPLICATION

This application is a continuation of International Application No. PCT/CN2018/101510, filed Aug. 21, 2018, the entire content of which is incorporated herein by reference.

### TECHNICAL FIELD

The present disclosure relates to distance measuring technologies and, more particularly, to a distance measuring method and device using an unmanned aerial vehicle.

### BACKGROUND

Measuring a distance to a certain building or sign is often needed in many industrial activities. Conventional laser ranging method is cumbersome and requires specialized equipment. For locations that are hard to access, measuring methods are even more limited.

Along with technology development nowadays, aerial vehicles such as unmanned aerial vehicles (UAVs) has been used in various application occasions. Existing distance measuring technologies using UAVs include: utilizing Global Positioning System (GPS) locations of an UAV or mounting specialized laser ranging equipment on an UAV, which can be complicated or ineffective. There is a need for developing autonomous operations in UAVs for distance measuring.

### SUMMARY

In accordance with the present disclosure, there is provided a method for measuring distance using an unmanned aerial vehicle (UAV). The method includes: identifying a target object to be measured; receiving a plurality of images captured by a camera of the UAV when the UAV is moving and the camera is tracking the target object; collecting movement information of the UAV corresponding to capturing moments of the plurality of images; and calculating a distance between the target object and the UAV based on the movement information and the plurality of images.

Also in accordance with the present disclosure, there is provided a system for measuring distance using an unmanned aerial vehicle (UAV). The system includes a camera of the UAV, at least one memory, and at least one processor coupled to the memory. The at least one processor is configured to identify a target object to be measured. The camera is configured to capture a plurality of images when the UAV is moving and the camera is tracking the target object. The at least one processor is further configured to collect movement information of the UAV corresponding to capturing moments of the plurality of images; and calculate a distance between the target object and the UAV based on the movement information and the plurality of images.

Also in accordance with the present disclosure, there is provided an unmanned aerial vehicle (UAV). The UAV includes a camera onboard the UAV and a processor. The processor is configured to: identify a target object to be measured; receive a plurality of images captured by the camera when the UAV is moving and the camera is tracking the target object; collect movement information of the UAV corresponding to capturing moments of the plurality of images; and calculate a distance between the target object and the UAV based on the movement information and the plurality of images.

Also in accordance with the present disclosure, there is provided a non-transitory storage medium storing computer readable instructions. When being executed by at least one processor, the computer readable instructions can cause the at least one processor to perform: identifying a target object to be measured; receiving a plurality of images captured by a camera of a UAV when the UAV is moving and the camera is tracking the target object; collecting movement information of the UAV corresponding to capturing moments of the plurality of images; and calculating a distance between the target object and the UAV based on the movement information and the plurality of images.

Also in accordance with the present disclosure, there is provided a method for measuring distance using an unmanned aerial vehicle (UAV). The method includes: identifying a target object; receiving a plurality of images captured by a camera of the UAV when the UAV is moving and the camera is tracking the target object; collecting movement information of the UAV corresponding to capturing moments of the plurality of images; and calculating a distance between a to-be-measured object contained in the plurality of images and the UAV based on the movement information and the plurality of images.

Also in accordance with the present disclosure, there is provided an unmanned aerial vehicle (UAV). The UAV includes a camera onboard the UAV and a processor. The processor is configured to: identify a target object; receive a plurality of images captured by the camera when the UAV is moving and the camera is tracking the target object; collect movement information of the UAV corresponding to capturing moments of the plurality of images; and calculate a distance between a to-be-measured object contained in the plurality of images and the UAV based on the movement information and the plurality of images.

### BRIEF DESCRIPTION OF THE DRAWINGS

FIG. 1 is a schematic diagram showing an operating environment according to exemplary embodiments of the present disclosure;

FIG. 2 is a schematic block diagram of a movable object according to exemplary embodiments of the present disclosure;

FIG. 3 illustrates image sensors of an UAV according to an exemplary embodiment of the present disclosure.

FIG. 4 is a schematic block diagram showing a computing device according to an exemplary embodiment of the present disclosure;

FIG. 5 is a flow chart of a distance measuring process according to an exemplary embodiment of the present disclosure;

FIG. 6 is a graphical user interface related to identifying a target object according to an exemplary embodiment of the present disclosure;

FIG. 7A is a super-pixel segmentation result image according to an exemplary embodiment of the present disclosure;

FIG. 7B is an enlarged portion of the image shown in in FIG. 7A;

FIG. 8 illustrates a distance calculation process according to an exemplary embodiment of the present disclosure; and

FIG. 9 illustrates a key frame extraction process according to an exemplary embodiment of the present disclosure.

### DESCRIPTION OF THE EMBODIMENTS

Hereinafter, embodiments consistent with the disclosure will be described with reference to the drawings, which are merely examples for illustrative purposes and are not intended to limit the scope of the disclosure. Wherever possible, the same reference numbers will be used throughout the drawings to refer to the same or like parts.

The present disclosure provides a method for measuring distance using unmanned aerial vehicle (UAV). Different from traditional ranging method, the disclosed method can, by implementing machine vision technology and integrating inertial navigation data from the UAV's own inertial measurement unit (IMU), provide distance measurement of an object selected by a user in real-time. The disclosed method is intuitive and convenient, and can provide reliable measurement result with fast calculation speed.

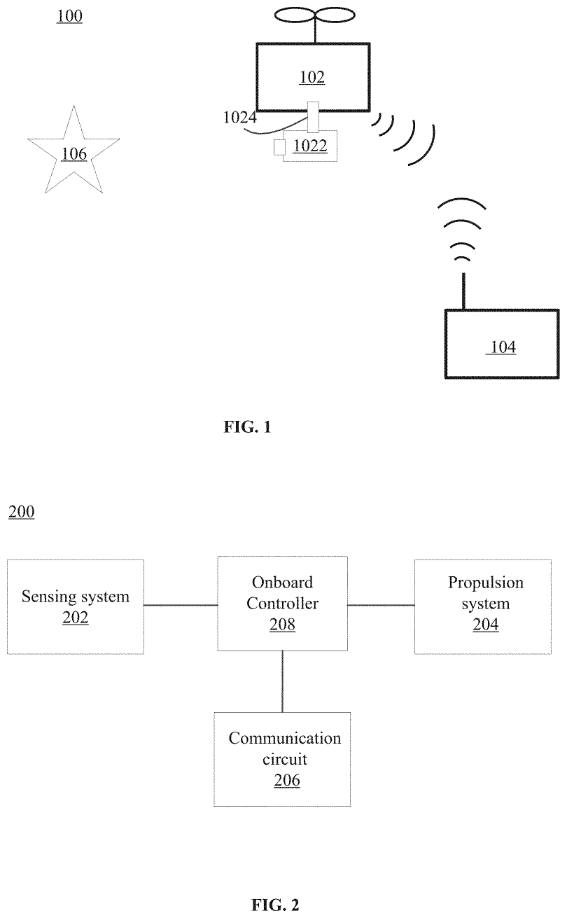

FIG. 1 is a schematic block diagram showing an operating environment according to exemplary embodiments of the present disclosure. As shown in FIG. 1, a movable object 102 may communicate with a remote control 104 wirelessly. The movable object 102 can be, for example, an unmanned aerial vehicle (UAV), a driverless car, a mobile robot, a driverless boat, a submarine, a spacecraft, a satellite, or the like. The remote control 104 may be a remote controller or a terminal device with an application (app) that can control the movable object 102. The terminal device can be, for example, a smartphone, a tablet, a game device, or the like. The movable object 102 can carry a camera 1022. Images or videos (e.g., consecutive image frames) captured by the camera 1022 of the movable object 102 may be transmitted to the remote control 104 and displayed on a screen coupled to the remote control 104. The screen coupled to the remote control 104, as used herein, may refer to a screen embedded with the remote control 104, and/or a screen of a display device operably connected to the remote control. The display device can be, for example, a smartphone or a tablet. The camera 1022 may be a payload of the movable object 102 supported by a carrier 1024 (e.g., a gimbal) of the movable object 102. The camera 1022 may track a target object 106 and an image captured by the camera 1022 may include the target object 106. Tracking an object by a camera, as used herein, may refer to using the camera to capture one or more images that contain the object. For example, the camera 1022 may capture multiple images of the target object 106 while the movable object 102 is moving in certain patterns. As the relative position between the target object 106 and the camera 1022 may change due to the movement of the movable object 102, the target object 106 may appear at different locations in the multiple images. It can be understood that, the captured multiple images may also contain one or more background objects other than the target object, and a background object may also appear at different locations in the multiple images. The movable object 102 may move in any suitable pattern, such as moving along a straight line, a polyline, an arc, a curved path, etc. The moving pattern may be predetermined or adjusted in real-time based on feedback from sensors of the movable object 102. One or more processors onboard and/or offboard the movable object 102 (e.g., a processor on a UAV and/or a processor in the remote control 104) are configured to calculate the distance between the movable object 102 (e.g., the camera 1022 of the movable object) and the target object 106 by, for example, analyzing the images captured by the camera 1022 and/or other sensor data collected by the movable object 102.

FIG. 2 is a schematic block diagram of a movable object according to exemplary embodiments of the present disclosure. As shown in FIG. 2, a movable object 200 (e.g., movable object 102), such as a UAV, may include a sensing system 202, a propulsion system 204, a communication circuit 206, and an onboard controller 208.

The propulsion system 204 may be configured to enable the movable object 200 to perform a desired movement (e.g., in response to a control signal from the onboard controller 208 and/or the remote control 104), such as taking off from or landing onto a surface, hovering at a certain position and/or orientation, moving along a certain path, moving at a certain speed toward a certain direction, etc. The propulsion system 204 may include one or more of any suitable propellers, blades, rotors, motors, engines and the like to enable movement of the movable object 200. The communication circuit 206 may be configured to establish wireless communication and perform data transmission with the remote control 104. The transmitted data may include sensing data and/or control data. The onboard controller 208 may be configured to control operation of one or more components on board the movable object 200 (e.g. based on analysis of sensing data from the sensing system 202) or an external device in communication with the movable object 200.

The sensing system 202 can include one or more sensors that may sense the spatial disposition, velocity, and/or acceleration of the movable object 200 (e.g., a pose of the movable object 200 with respect to up to three degrees of translation and/or up to three degrees of rotation). Examples of the sensors may include but are not limited to: location sensors (e.g., global positioning system (GPS) sensors, mobile device transmitters enabling location triangulation), image sensors (e.g., imaging devices capable of detecting visible, infrared, and/or ultraviolet light, such as camera 1022), proximity sensors (e.g., ultrasonic sensors, lidar, time-of-flight cameras), inertial sensors (e.g., accelerometers, gyroscopes, inertial measurement units (IMUs)), altitude sensors, pressure sensors (e.g., barometers), audio sensors (e.g., microphones) or field sensors (e.g., magnetometers, electromagnetic sensors). Any suitable number and/or combination of sensors can be included in the sensing system 202. Sensing data collected and/or analyzed by the sensing system 202 can be used to control the spatial disposition, velocity, and/or orientation of the movable object 200 (e.g., using a suitable processing unit such as the onboard controller 206 and/or the remote control 104). Further, the sensing system 202 can be used to provide data regarding the environment surrounding the movable object 200, such as proximity to potential obstacles, location of geographical features, location of manmade structures, etc.

In some embodiments, the movable object 200 may further include a carrier for supporting a payload carried by the movable object 200. The carrier may include a gimbal that carries and controls a movement and/or an orientation of the payload (e.g., in response to a control signal from the onboard controller 208), such that the payload can move in one, two, or three degree of freedom relative to the central/main body of the movable object 200. The payload may be a camera (e.g., camera 1022). In some embodiments, the payload may be fixedly coupled to the movable object 200.

In some embodiments, the sensing system 202 include at least an accelerometer, a gyroscope, an IMU, and an image sensor. The accelerometer, the gyroscope, and the IMU may be positioned at the central/main body of the movable object 200. The image sensor may be a camera positioned in the central/main body of the movable object 200 or may be the payload of the movable object 200. When the payload of the movable object 200 includes a camera carried by a gimbal, the sensing system 202 may further include other components to collect and/or measure pose information of the payload camera, such as photoelectric encoder, Hall effect sensor, and/or a second set of accelerometer, gyroscope, and/or IMU positioned at or embedded in the gimbal.

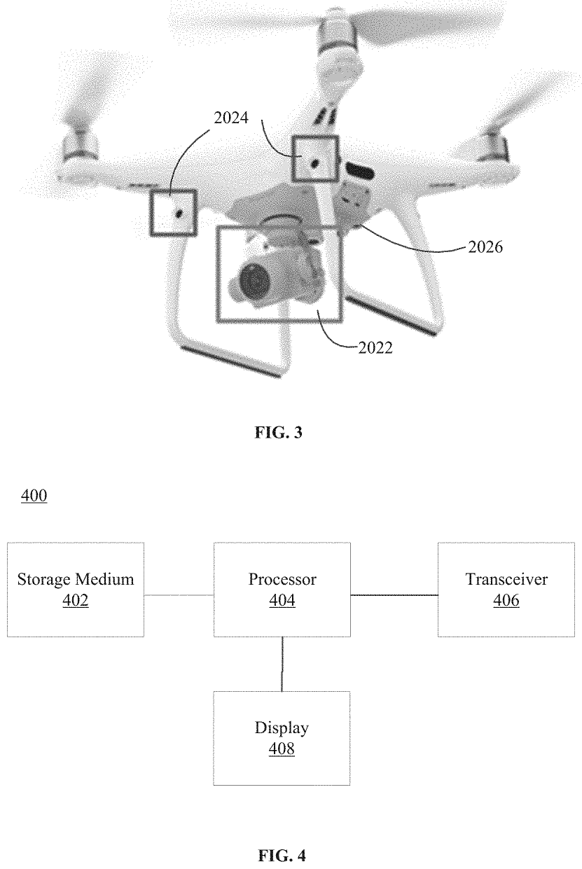

In some embodiments, the sensing system 202 may further include multiple image sensors. FIG. 3 illustrates image sensors of a UAV according to an exemplary embodiment of the present disclosure. As shown in FIG. 3, the UAV includes a camera 2022 carried by a gimbal as a payload, a forward vision system 2024 including two lenses (which together constitute a stereo vision camera), and a downward vision system 2026 including a stereo vision camera. Images/videos collected by any image sensor may be transmitted to and displayed on the remote control 104 of the UAV. In some embodiments, the camera 2022 may be referred as a main camera. The distance to the target object 106 can be measured by tracking camera poses of the main camera when capturing a plurality of images and analyzing the captured plurality of images containing the target object 106. In some embodiments, the camera 2022 carried by the gimbal may be a monocular camera that captures color images.

In some embodiments, in a camera model used herein, a camera matrix is used to describe a projective mapping from three-dimensional (3D) world coordinates to two-dimensional (2D) pixel coordinates. Let [u, v, 1]^{T} denotes a 2D point position in homogeneous/projective coordinates (e.g., 2D coordinates of a point in the image), and let [x_{w}, y_{w}, z_{w}]^{T} denotes a 3D point position in world coordinates (e.g., 3D location in real world), where z_{c} denotes z-axis from an optical center of the camera, K denotes a camera calibration matrix, R denotes a rotation matrix, and T denotes a translation matrix. The mapping relationship from world coordinates to pixel coordinates can be described by:

$${z}_{c} [ \begin{matrix}u \\ v \\ 1\end{matrix} ] = K [ R T ] [ \begin{matrix}{x}_{w} \\ {y}_{w} \\ {z}_{w} \\ 1\end{matrix} ]$$

The camera calibration matrix K describes intrinsic parameters of a camera. For a finite projective camera, its intrinsic matrix K includes five intrinsic parameters:

$$K = [ \begin{matrix}{α}_{x} & γ & {μ}_{0} \\ 0 & {α}_{y} & {v}_{0} \\ 0 & 0 & 1\end{matrix} ]$$

where f is the focal length of the camera in terms of distance. The parameters αₓ=fmₓ, α_{y}=fm_{y} represent focal length in terms of pixels, where mₓ and m_{y} are scale factors in x-axis and y-axis directions (e.g. of the pixel coordinate system) relating pixels to unit distance, i.e., the number of pixels that correspond to a unit distance, such as one inch. γ represents the skew coefficient between x-axis and y-axis, since a pixel is not a square in a CCD (couple-charged device) camera. μ₀, v₀ represent the coordinates of the principal point, which, in some embodiments, is at the center of the image.

The rotation matrix R and the translation matrix T are extrinsic parameters of a camera, which denote the coordinate system transformations from 3D world coordinates to 3D camera coordinates.

The forward vision system 2024 and/or the downward vision system 2026 may include a stereo camera that captures grayscale stereo image pairs. A sensory range of the camera 2022 may be greater than a sensory range of the stereo camera. A visual odometry (VO) circuit of the UAV may be configured to analyze image data collected by the stereo camera(s) of the forward vision system 2024 and/or the downward vision system 2026. The VO circuit of the UAV may implement any suitable visual odometry algorithm to track position and movement of the UAV based on the collected grayscale stereo image data. The visual odometry algorithm may include: tracking location changes of a plurality of feature points in a series of captured images (i.e., optical flow of the feature points) and obtaining camera motion based on the optical flow of the feature points. In some embodiments, the forward vision system 2024 and/or the downward vision system 2026 are fixedly coupled to the UAV, and hence the camera motion/pose obtained by the VO circuit can represent the motion/pose of the UAV. By analyzing location changes of the feature points from one image at a first capturing moment to another image at a second capturing moment, the VO circuit can obtain camera/UAV pose relationship between the two capturing moments. A camera pose relationship or a UAV pose relationship between any two moments (i.e., time points), as used herein, may be described by: rotational change of the camera or UAV from the first moment to the second moment, and spatial displacement of the camera or UAV from the first moment to the second moment. A capturing moment, as used herein, refers to a time point that an image/frame is captured by a camera onboard the movable object. The VO circuit may further integrate inertial navigation data to obtain the pose of the camera/UAV with enhanced accuracy (e.g., by implementing a visual inertial odometry algorithm).

FIG. 4 is a schematic block diagram showing a computing device 400 according to an exemplary embodiment of the present disclosure. The computing device 400 may be implemented in the movable object 102 and/or the remote control 104, and can be configured to perform a distance measuring method consistent with the disclosure. As shown in FIG. 4, the computing device 400 includes at least one processor 404, at least one storage medium 402, and at least one transceiver 406. According to the disclosure, the at least one processor 404, the at least one storage medium 402, and the at least one transceiver 406 can be separate devices, or any two or more of them can be integrated in one device. In some embodiments, the computing device 400 may further include a display 408.

The at least one storage medium 402 can include a non-transitory computer-readable storage medium, such as a random-access memory (RAM), a read only memory, a flash memory, a volatile memory, a hard disk storage, or an optical medium. The at least one storage medium 402 coupled to the at least one processor 404 may be configured to store instructions and/or data. For example, the at least one storage medium 402 may be configured to store data collected by an IMU, image captured by a camera, computer executable instructions for implementing distance measuring process, and/or the like.

The at least one processor 404 can include any suitable hardware processor, such as a microprocessor, a micro-controller, a central processing unit (CPU), a network processor (NP), a digital signal processor (DSP), an application specific integrated circuit (ASIC), a field-programmable gate array (FPGA), or another programmable logic device, discrete gate or transistor logic device, discrete hardware component. The at least one storage medium 402 stores computer program codes that, when executed by the at least one processor 404, control the at least one processor 404 and/or the at least one transceiver 406 to perform a distance measuring method consistent with the disclosure, such as one of the exemplary methods described below. In some embodiments, the computer program codes also control the at least one processor 404 to perform some or all of the functions that can be performed by the movable object and/or the remote control as described above, each of which can be an example of the computing device 400.

The at least one transceiver 406 is controlled by the at least one processor 404 to transmit data to and/or receive data from another device. The at least one transceiver 406 may include any number of transmitters and/or receivers suitable for wired and/or wireless communication. The transceiver 406 may include one or more antennas for wireless communication at any supported frequency channel. The display 408 may include one or more screens for displaying contents in the computing device 400 or transmitted from another device, e.g., displaying an image/video captured by a camera of the movable object, displaying a graphical user interface requesting user input to determine a target object, displaying a graphical user interface indicating a measured distance to the target object, etc. In some embodiments, the display 408 may be a touchscreen display configured to receive touch inputs/gestures by a user. In some embodiments, the computing device 400 may include other I/O (input/output) devices, such as a joy stick, a control panel, a speaker, etc. In operation, the computing device 400 may implement a distance measuring method as disclosed herein.

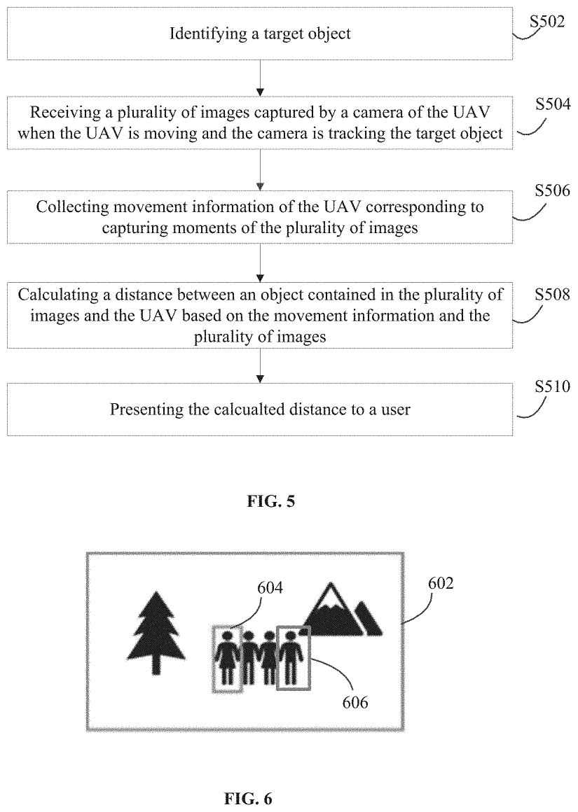

The present disclosure provides a distance measuring method. FIG. 5 is a flow chart of a distance measuring process according to an exemplary embodiment of the present disclosure. The disclosed distance measuring process can be performed by the movable object 102 and/or the remote control 104. The disclosed distance measuring process can be implemented by a system including a processor, a storage medium, and a camera onboard a movable object. The storage medium may store computer readable instructions executable by the processor, and the computer readable instructions can cause the processor to perform the disclosed distance measuring method. UAV is used hereinafter as an example of the movable object 102 in describing the disclosed method. It is understood, however, that the disclosed method can be implemented by any suitable movable object.

As shown in FIG. 5, the disclosed method may include identifying a target object (S502). The target object is identified from an image based on user input. The image may be captured by the camera 1022 and may be displayed on the remote control 104.

In some embodiments, a human-machine interaction terminal (e.g., remote control 104) such as a smart phone, a smart tablet, smart glasses may receive a user selection on a target object to be measured. FIG. 6 is a graphical user interface related to identifying a target object according to an exemplary embodiment of the present disclosure. As shown in FIG. 6, the graphical user interface may display an initial image 602. The initial image 602 may be displayed on a screen of a remote control in communication with the UAV. The initial image 602 may be a real-time image captured by and transmitted from the UAV. The remote control may allow a user to identify a target area 604 in the initial image 602. The target area 604 may be identified based on user selection, such as a single tap at a center of the target area, a double tap at an arbitrary location in the target area, a single/double tap on a first corner point and a single/double tap on a second corner point that define a bounding box of the target area, a free drawing of a shape enclosing the target area, or a dragging operation having a starting point and an ending point that define a bounding box of the target area. When the user input identifies only one point in the image as corresponding to the target object, an image segmentation process may be performed to obtain multiple segmented image sections, and the target area can be determined as a segmented section that includes the identified point. In some embodiments, the user input may be an object name or an object type. A pattern recognition or image classification algorithm may be implemented to identify one or more objects in the initial image based on names/types, and an object matching the name or type inputted by the user is determined as the target object.

In some embodiments, while the camera of the UAV is tracking the target object (i.e., capturing images containing the target object), the user may request to measure a distance to another object which is also contained in the captured images, for example, by selecting an area corresponding to the to-be-measured object in an image shown on the graphical user interface, or by inputting a name or a type of the to-be-measured object. The to-be-measured object may be a background object of the target object. In other words, both the target object and the background object are contained in multiple images captured by the camera of the UAV.

In some embodiments, identifying the to-be-measured object may include: obtaining a user selection of an area in one of the plurality of images displayed on a graphical user interface; and obtaining the to-be-measured object based on the selected area. For example, as shown in FIG. 6, the user may select area 606 as the area corresponding to the to-be-measured object. In some other embodiments, identifying the to-be-measured object may include: automatically identifying at least one object other than the target object contained in one of the plurality of images; receiving a user instruction specifying the to-be-measured object; and obtaining the to-be-measured object from the at least one identified object based on the user instruction. A pattern recognition or image classification algorithm may be implemented to automatically identify one or more objects in a captured image based on names, types, or other object characteristics. For example, the identified objects may be: an umbrella, an orange car, a building with flat roof top. Further, an object matching the name or type inputted by the user is determined as the to-be-measured object. The object identification may be performed after receiving a user input on the specific name or type. Alternatively, a plurality of identified objects may be presented on the graphical user interface (e.g., by listing the names/characteristics of the objects, or by displaying bounding boxes corresponding to the objects in the image), and a user selection of one object (e.g., selection on one name or one bounding box) is received to determine the to-be-measured object.

In some embodiments, identifying an object in an image may include identifying an area in the image that represents the object. For example, identifying the target object may include identifying an area in the initial image that represents the target object based on user input. It can be understood that the disclosed procedure in identifying the target object in the initial image can be applied in identifying any suitable object in any suitable image. In some embodiments, the target area is considered as the area representing the target object. In some embodiments, user selection of the target area may not be an accurate operation, and the initially identified target area may indicate an approximate position and size of the target object. The area representing the target object can be obtained by refining the target area according to the initial image, such as by implementing a super-pixel segmentation method.

A super-pixel can include a group of connected pixels with similar textures, colors, and/or brightness levels. A super-pixel may be an irregularly-shaped pixel block with certain visual significance. Super-pixel segmentation includes dividing an image into a plurality of non-overlapping super-pixels. In one embodiment, super-pixels of the initial image can be obtained by clustering pixels of the initial image based on image features of the pixels. Any suitable super-pixel segmentation algorithm can be used, such as simple linear iterative clustering (SLIC) algorithm, Graph-based segmentation algorithm, N-Cut segmentation algorithm, Turbo pixel segmentation algorithm, Quick-shift segmentation algorithm, Graph-cut a segmentation algorithm, Graph-cut b segmentation algorithm, etc. It can be understood that the super-pixel segmentation algorithm can be used in both color images and grayscale images.

Further, one or more super-pixels located in the target area can be obtained, and an area formed by the one or more super-pixels can be identified as the area representing the target object. Super-pixels located outside the target area are excluded. For a super-pixel partially located in the target area, a percentage can be determined by dividing a number of pixels in the super-pixel that are located inside the target area by a total number of pixels in the super-pixel. The super-pixel can be considered as being located in the target area if the percentage is greater than a preset threshold (e.g., 50%). The preset threshold can be adjusted based on actual applications.

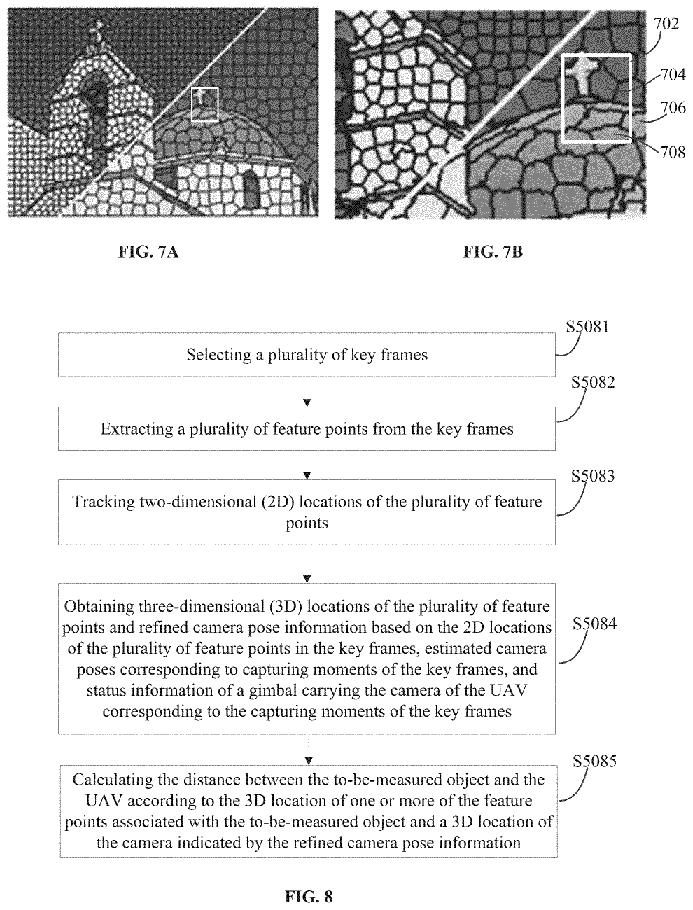

FIG. 7A illustrates a super-pixel segmentation result image according to an exemplary embodiment of the present disclosure. FIG. 7B illustrates an enlarged portion of the image shown in in FIG. 7A. As shown in FIG. 7B, multiple super-pixels are located entirely or partially within the user-selected target area 702, including super-pixels 704, 706, and 708. Super-pixel 704 is entirely enclosed in the target area 702 and is considered as being included in the area representing the target object. In some embodiments, the preset percentage threshold may be 50%. Accordingly, in these embodiments, super-pixel 706 is excluded from the area representing the target object because less than 50% of super-pixel 706 is located within the target area 702. On the other hand, super-pixel 708 is included in the area representing the target object because more than 50% of super-pixel 708 is located within the target area 702.

In some embodiments, the disclosed method may include presenting a warning message indicating a compromised measurement accuracy after identifying the target object. In some occasions, the target object may possess certain characteristics that affect measurement accuracy, such as when the target object is potentially moving quickly or when the target object does not include enough details to be tracked. The remote control may present the warning message and a reason of potentially compromised measurement accuracy if it determines that the target object possesses one or more of the certain characteristics. In some embodiments, the warning message may further include options of abandoning or continuing with the measurement, and measurement steps can be continued after receiving a confirmation selection based on user input.

In some embodiments, the disclosed method may include determining whether the target object is a moving object. In some embodiments, the disclosed method may further include presenting a warning message indicating a compromised measurement accuracy if the target object is determined to be a moving object. For example, a convolutional neural network (CNN) may be implemented on the target object to identify a type of the target object. The type of the target object may be one of, for example, a high-mobility type indicating that the target object has a high probability to move, such as a person, an animal, a car, an aircraft, or a boat, a low-mobility type indicating that the target object has a low probability to move, such as a door or a chair, and a no-mobility type, such as a building, a tree, or a road sign. The warning message may be presented accordingly. In some embodiments, the disclosed method may include determining whether a moving speed of the target object is below a preset threshold. That is, the disclosed method may provide accurate measurement of the distance to the target object if the target object moves below a certain threshold speed. In some embodiments, the disclosed method may further include presenting a warning message indicating a compromised measurement accuracy if the moving speed of the target object is no less than the preset threshold.

In some embodiments, the disclosed method may include extracting target feature points corresponding to the target object (e.g., the area representing the target object in the initial image), determining whether a quantity of the target feature points is less than a preset quantity threshold. In some embodiments, the disclosed method may further include presenting a warning message indicating a compromised measurement accuracy in response to the quantity of the target feature points being less than the preset quantity threshold. Whether the target object can be tracked in a series of image frames can be determined based on whether the target object includes enough texture details or enough number of feature points. The feature points may be extracted by any suitable feature extraction methods, such as Harris Corner detector, HOG (histogram of oriented gradients) feature descriptor, etc.

In some embodiments, when a target area of the target object is determined, the graphical user interface on the remote control may display, for example, borderlines or a bounding box of the target area overlaying on the initial image, a warning message in response to determining a potentially compromised measurement accuracy, and/or options to confirm continuing distance measurement and/or further edit the target area.

Referring again to FIG. 5, a camera of the UAV may track the target object and capture a series of images when the UAV is moving and a processor may receive the captured images (S504). In other words, the camera onboard the UAV may capture the series of images containing the target object when the UAV is moving. In some embodiments, image capturing may be a routine operation of the UAV (e.g., at a fixed frequency), and the remote control may receive real-time transmission of captured images from the UAV and display on the screen. A routine operation of the UAV refers to an operation of the UAV that may normally be performed during a flight of the UAV. Besides image capturing, a routine operation can include hovering stably when no movement control is received, automatically avoiding obstacles, responding to control command from a remote control (e.g., adjusting flight altitude, speed, and/or direction based on user input to the remote control, flying towards a location selected by the user on the remote control), and/or providing feedbacks to remote control (e.g., reporting location and flight status, transmitting real-time image). Determining moving direction and/or speed of the UAV may be an operation facilitating the distance measuring. In the beginning of the distance measuring process, the UAV may move at an initial speed along an arc or a curved path having an initial radius around the target object. The target object may be located at or near the center of the arc or the curved path. The initial radius may be an estimated distance between the target object and the UAV. In some embodiments, the initial speed may be determined based on the initial radius. For example, the initial speed may have a positive correlation with the initial radius.

In some embodiments, the estimated distance between the target object and the UAV may be determined based on data obtained from a stereoscopic camera (e.g., forward vision system 2024) of the UAV. For example, after identifying the target object in the initial image captured by the main camera (e.g., camera 2022) of the UAV, images captured by the stereoscopic camera at a substantially same moment can be analyzed to obtain a depth map. That is, the depth map may also include an object corresponding to the target object. The depth of the corresponding object can be used as the estimated distance between the target object and the UAV. It can be understood that, the estimated distance between the target object and the UAV may be determined based on data obtained from any suitable depth sensor on the UAV, such as a laser sensor, an infrared sensor, a radar, etc.

In some embodiments, the estimated distance between the target object and the UAV may be determined based on a preset value. The preset value may be a farthest distance measurable by the UAV (e.g., based on a resolution of the main camera of the UAV). For example, when it is difficult to identify the object corresponding to the target object in the depth map, the initial radius may be directly determined as the preset value.

In some embodiments, when the UAV is moving, sensing data of the UAV, such as image captured by the camera, may be used as feedback data, and at least one of a velocity of the UAV, a moving direction of the UAV, a rotation degree of the UAV, or a rotation degree of a gimbal carrying the camera may be adjusted based on the feedback data. As such, a closed-loop control may be realized. The feedback data may include pixel coordinates corresponding to the target object in a captured image. In some embodiments, the rotation degree of the gimbal carrying the camera may be adjusted to ensure that the target object is included in the captured image. In other words, the target object is tracked by the camera. In some cases, the target object is tracked at certain predetermined positions (e.g., image center) or a certain predetermined size (e.g., in pixels). That is, the rotation degree of the gimbal may be adjusted when a part of the target object is not in the captured image as determined based on the feedback data. For example, if remaining pixels corresponding to the target object are located at an upper edge of the captured image, the gimbal may rotate the camera upward for a certain degree to ensure that a next captured image includes the entire target object. In some embodiments, the speed of the UAV may be adjusted based on location difference of the target object (e.g., 2D coordinates of matching super-pixels) in a current image and in a previously captured image. The current image and the previously captured image may be two consecutively captured frames, or frames captured at a predetermined interval. For example, if the location difference is less than a first threshold, the speed of the UAV may be increased; and if the location difference is greater than a second threshold, the speed of the UAV may be decreased. In other words, the location difference of the target object in the two images being less than a first threshold suggests redundant information are being collected and analyzed, so the speed of the UAV may be increased to create enough displacement between frames to save computation power/resource and speed up the measurement process. On the other hand, a large location difference of the target object in two images may cause difficulty in tracking same feature points among multiple captured images and lead to inaccurate results, so the speed of the UAV may be decreased to ensure measurement accuracy and stability. In some embodiments, if the user requests to measure a distance to a background object other than the target object, the movement of the UAV and/or the gimbal may be adjusted based on location difference of the background object in a current image and in a previously captured image.

In some embodiments, the movement of the UAV may be manually controlled based on user input. When determining that the speed of the UAV or the rotation degree of the gimbal should be adjusted based on the feedback data, the remote control may prompt the user to request automated correction or provide suggestion to the manual operation (e.g., displaying a prompt message or play an audio message such as “slowing down to measure the distance”). In some embodiments, when manual input is not present, the UAV may conduct an automated flight based on a preset procedure for distance measurement (e.g., selecting an initial speed and radius, adjusting speed and rotation degree based on feedback data as described above).

When the UAV is moving and capturing images, movement information of the UAV corresponding to capturing moments of the images is also collected (S506). The movement information may include various sensor data recorded by the UAV, such as readings of accelerometer and gyroscope when the UAV is moving. In some embodiments, the movement information may include pose information of a gimbal carrying the main camera, such as rotation degree of the gimbal. In some embodiments, the movement information may further include other sensor data regularly produced for routing operations of the UAV, such as UAV pose relationships obtained from IMU and VO circuit when the UAV is moving, pose information (e.g., orientation and position) of the UAV in world coordinate system obtained from integration of IMU data, VO data, and GPS data. It can be understood that capturing images of the target object (S504) and collecting the movement information of the UAV (S506) may be performed at the same time as the UAV is moving. Further, the captured images and the collected movement information in S504 and S506 may include data regularly generated for routine operations and can be directly obtained and utilized for distance measuring.

A distance between an object contained in multiple captured images and the UAV can be calculated based on the multiple captured images and movement information corresponding to capturing moments of the multiple images (S508). The to-be-measured object may be the target object or a background object which is also contained in the multiple images. By analyzing data from the IMU and VO circuit together with the images captured by the main camera, 3D locations of image points and camera pose information corresponding to capturing moments of the multiple images can be determined. Further, the distance to an object contained in the multiple images can be determined based on the 3D locations of image points. The distance calculation may be performed on the UAV and/or the remote control.

FIG. 8 illustrates a distance calculation process according to an exemplary embodiment of the present disclosure. As shown in FIG. 8, in an exemplary embodiment, a plurality of key frames may be selected from consecutive image frames captured by the main camera (S5081).

The selected key frames may form a key frame sequence. In some embodiments, an original sequence of image frames are captured at a fixed frequency and certain original image frames may not be selected as key frames if they do not satisfy a certain condition. In some embodiments, the key frames include image frames captured when the UAV is moving steadily (e.g., small rotational changes). In some embodiments, a current image frame is selected as a new key frame if a position change from the most recent key frame to the current image frame is greater than a preset threshold (e.g., notable displacement). In some embodiments, the first key frame may be the initial image, or an image captured within certain time period of the initial image when the UAV is in a steady state (e.g., to avoid motion blur). An image frame captured after the first key frame can be determined and selected as key frame based on pose relationships between capturing moments of the image frame and a most recent key frame. In other words, by evaluating pose relationships of the main camera at two capturing moments (e.g., rotational change and displacement of the main camera from a moment that the most recent key frame is captured to a moment that the current image frame is captured), whether the current image frame can be selected as key frame can be determined.

In some embodiments, as the UAV is moving and the camera is capturing image frames, a new key frame can be determined and added to the key frame sequence. Each key frame may have a corresponding estimated camera pose of the main camera. The estimated camera pose may be obtained by incorporating IMU data of the UAV, the VO data of the UAV, and a position/rotation data of the gimbal carrying the main camera. When the key frames in the key frame sequence reach a certain number m (e.g., 10 key frames), they are ready to be used in calculating the distance to the to-be-measured object.

When a key frame is determined, feature extraction may be performed for each key frame (S5082). In some embodiments, the feature extraction may be performed as soon as one key frame is determined/selected. That is, feature extraction of a key frame can be performed at the same time when a next key frame is being identified. In some other embodiments, the feature extraction may be performed when a certain number of key frames are determined, such as when all key frames in the key frame sequence are determined. Any suitable feature extraction method can be implemented here. For example, sparse feature extraction may be used to reduce the amount of calculation. Corner detection algorithm can be performed to obtain corner points as feature points, such as FAST (features from accelerated segment test), SUSAN (smallest univalue segment assimilating nucleus) corner operator, Harris corner operator, etc. Using Harris corner detection algorithm as an example, given an image point I, consider taking an image patch over the area (u, v) and shifting it by (u, v) a structure tensor A is defined as follows:

$$A = {\sum }_{u} {\sum }_{v} w ( u , v ) [ \begin{matrix}{I}_{x}^{2} & {I}_{x} {I}_{y} \\ {I}_{x} {I}_{y} & {I}_{y}^{2}\end{matrix} ] = [ \begin{matrix}〈 {I}_{x}^{2} 〉 & 〈 {I}_{x} {I}_{y} 〉 \\ 〈 {I}_{x} {I}_{y} 〉 & 〈 {I}_{y}^{2} 〉\end{matrix} ]$$

where Iₓ and I_{y} are partial derivatives of point I. The gradient information at x-direction and y-direction M_{c} corresponding to the image point can be defined as follows:

M_{c}=λ₁λ₂−κ(λ₁+λ₂)²=det(A)−κtrace² (A)

where det(A) is determinantA, trace(A) is traceA, κ is tunable sensitivity parameter. A threshold Mₜₕ can be set. When M_{c}>Mₜₕ, the image point is considered as a feature point.

Feature points in one key frame may appear in one or more other key frames. In other words, two consecutive key frames may include matching feature points describing same environments/objects. 2D locations of such feature points in the key frames may be tracked to obtain optical flow of the feature points (S5083). Any suitable feature extraction/tracking and/or image registration method may be implemented here. Using Kanade-Lucas-Tomasi (KLT) feature tracker as an example, provided that h denotes a displacement between two images F(x) and G(x), and G(x)=F(x+h), the displacement for a feature point in the key frames can be obtained based on iterations of the following equation:

$$\{ \begin{matrix}{h}_{0} = 0 \\ {h}_{k + 1} = {h}_{k} + \frac{{\sum }_{x} w ( x ) {F}^{′} ( x + {h}_{x} ) [ G ( x ) - F ( x + {h}_{k} ) ]}{{\sum }_{x} w ( x ) {{F}^{′} ( x + {h}_{x} )}^{2}}\end{matrix} \\ where {F}^{′} ( x ) \approx \frac{F ( x + h ) - F ( x )}{h} = \frac{G ( x ) - F ( x )}{h} .$$

F(x) is captured earlier than G(x), w(x) is a weighting function, and x is a vector representing location. Further, after obtaining the displacement of a current image relative to a previous image h, an inverse calculation can be performed to obtain a displacement of the previous image relative to the current image h′. Theoretically h=−h′. If actual calculation satisfies the theoretical condition, i.e., h=−h′, it can be determined that the feature point is tracked correctly, i.e., a feature point in one image matches a feature point in another image. In some embodiments, the tracked feature points can be identified in some or all of the key frames, and each tracked feature point can be identified in at least two consecutive frames.

Based on 2D locations of the tracked feature points in the keyframes, three-dimensional (3D) locations of the feature points and refined camera pose information can be obtained (S5084) by solving an optimization problem on the 3D structure of the scene geometry and viewing parameters related to camera pose. In an exemplary embodiment, bundle adjustment (BA) algorithm for minimizing the reprojection error between the image locations of observed and predicted image points can be used in this step. Given a set of images depicting a number of 3D points from different viewpoints (i.e., feature points from the key frames), bundle adjustment can be defined as the problem of simultaneously refining the 3D coordinates describing the scene geometry, the parameters of the relative motion (e.g., camera pose changes when capturing the key frames), and the optical characteristics of the camera employed to acquire the images, according to an optimality criterion involving the corresponding image projections of all points. A mathematical representation of the BA algorithm is:

$${min}_{{a}_{j} , {b}_{i}} {\sum }_{i = 1}^{n} {\sum }_{j = 1}^{m} {v}_{ij} {d ( Q ( {a}_{j} , {b}_{i} ) , {x}_{ij} )}^{2}$$

where i denotes an ith tracked 3D points (e.g., the tracked feature points from S5083), n is the number of tracked points, and bᵢ denotes 3D location of the ith point. j denotes a jth image (e.g., the key frames from S5081), m is the number of images, and αⱼ denotes camera pose information of the jth image, including rotation information R, translation information T, and/or intrinsic parameter K. vᵢⱼ indicates whether the ith point has a projection in the jth image; and vᵢⱼ=1 if the jth image includes the ith point, otherwise, vᵢⱼ=0. Q(aⱼ, bᵢ) is a predicted projection of the ith point in the jth image based on the camera pose information aⱼ. xᵢⱼ is a vector describing the actual projection of the ith point in the jth image (e.g., 2D coordinates of the point in the image). d(x1, x2) denotes Euclidean distance between the image points represented by vectors x1 and x2.

In some embodiments, bundle adjustment amounts to jointly refining a set of initial camera and structure parameter estimates for finding the set of parameters that most accurately predict the locations of the observed points in the set of available images. The initial camera and structure parameter estimates, i.e., initial values of aⱼ, are estimated camera pose information obtained based on routine operation data from the IMU of the UAV and the VO circuit of the UAV. That is, in maintaining routine operations of the UAV, the IMU and the VO circuit may analyze sensor data to identify pose information of the UAV itself. The initial value of estimated camera pose of the camera capturing the key frames can be obtained by combining the pose information of the UAV at matching capturing moments and pose information of the gimbal carrying the camera at matching capturing moments. In one embodiment, the initial value of the estimated camera pose may further integrate GPS data of the UAV.

The distance between the to-be-measured object and the UAV can be obtained according to the 3D location of one or more feature points associated with the to-be-measured object (S5085). The target object is used hereinafter as an example of the to-be-measured object in describing embodiments of distance calculation and size determination. It can be understood that the disclosed procedures related to the target object can be applied for any suitable to-be-measured object contained in the key frames. In some embodiments, the distance to the target object is considered as the distance to a center point of the target object. The center point of the target object may be, for example, a geometric center of the target object, a centroid of the target object, or a center of a bounding box of the target object. The center point may be or may not be included in the extracted feature points from S5082. When the center point is included in the extracted feature points, the distance to the center point can be directly determined based on the 3D location of the center point obtained from bundle adjustment result.

In one embodiment, when the center point is not included in the extracted feature points from S5082, tracking the 2D locations of the feature points in the key frames (S5083) may further include adding the center point to the feature points and tracking 2D locations of the center point of the target object in the key frames according to an optical flow vector of the center point obtained based on the optical flow vectors of target feature points. In some embodiments, the target feature points may be feature points extracted from S5082 and located within an area of the target object. That is, by adding the center point as tracked points for the BA algorithm calculation, the 3D location of the center point can be directly obtained from the BA algorithm result. Mathematically, provided that xᵢ denotes an optical flow vector of an ith target feature point and there are n feature points within the area corresponding to the target object, the optical flow vector of the center point x₀ can be obtained by:

$${x}_{0} = {\sum }_{n} {w}_{i} {x}_{i}$$

where wᵢ is a weight corresponding to the ith target feature point based on a distance between the center point and the ith target feature point. In one embodiment, wᵢ can be obtained based on a Gaussian distribution as follows:

$${w}_{i} = {e}^{- \frac{{d}_{i}}{2 {σ}^{2}}}$$

where σ can be adjusted based on experience, and dᵢ denotes the distance between the center point and the ith target feature point on the image, i.e., dᵢ=\sqrt{(uᵢ−u₀)²+(vᵢ−v₀)²}, where (uᵢ, vᵢ) is 2D image location of the ith target feature point, and (u₀, v₀) is 2D image location of the center point. In some embodiments, some of the target feature points used in obtaining the optical flow vector of the center point may not be necessarily within an area of the target object. For example, feature points whose 2D locations are within a certain range of the center point can be used as the target feature points. Such range may be greater than the area of the target object to, for example, include more feature points in calculating the optical flow vector of the center point. It can be understood that, similar approaches of obtaining optical flow vector of a point and adding the point into the BA calculation can be used to obtain 3D location of the point other than the center point based on 2D location relationships between the to-be-added point and the extracted feature points. For example, corner points of the target object can be tracked and added to the BA calculation, and a size of the target object may be obtained based on 3D locations of corner points of the target object.

In another embodiment, when the center point is not included in the extracted feature points from S5082, calculating the distance to the target object according to the 3D location of one or more feature points associated with the target object (S5085) may further include determining a 3D location of the center point based on the 3D locations of a plurality of target feature points. Feature points located within a range of the center point in the 2D images can be identified and the depth information of the identified feature points can be obtained based on their 3D locations. In one example, a majority of the identified feature points may have same depth information or similar depth information within a preset variance range, and can be considered as located in a same image plane as the target object. That is, the majority depth of the identified feature points can be considered as the depth of the target object, i.e., the distance between the target object and the UAV. In another example, a weighted average of the depths of the identified feature points can be determined as the depth of the target object. The weight can be determined based on a distance between the center point and the identified feature point.

In some embodiments, the size of the target object may be obtained based on the distance between the target object and the UAV. The size of the target object may include, for example, a length, a width, a height, and/or a volume of the target object. In one embodiment, assuming the target object is a parallelepiped such as a cuboid, the size of the target object can be obtained by evaluating 3D coordinates of two points/vertices of body diagonal of the target object. In one embodiment, a length or a height of the target object in a 2D image can be obtained in pixel units (e.g., 2800 pixels), and based on a ratio of the depth of the target object and the focal length of the camera (e.g., 9000 mm/60 mm) and camera sensor definition (200 pixel/mm), the length or height of the target object in regular unit of length can be obtained (e.g., 2.1 m).

Referring again to FIG. 5, the disclosed method further includes presenting the calculated distance to a user (S510). For example, the distance may be displayed on a graphical user interface, and/or broadcasted in an audio message. In some embodiments, the remote control may display captured images on the graphical user interface and mark the distance on an image currently displayed on the graphical user interface. Further, the image currently displayed on the graphical user interface may be the initial image with the identified to-be-measured object, or a live feed image containing the to-be-measured object.

In some embodiments, the distance between an object (e.g., the target object or the background object) and the UAV may be updated in real time based on additional second images captured by the camera and movement information corresponding to capturing moments of the second images. After 3D locations of the object corresponding to the key frames (e.g., from S5084 and S5085) are obtained, when a new image (e.g., a second image) is captured at an arbitrary moment after the 3D location of the object is determined, the location of the object corresponding to the second image can be obtained by combining the 3D location of the object corresponding to the last key frame and camera pose relationship between capturing moments of the last key frame and the second image. In some embodiments, the distance may be updated at certain time intervals (e.g., every second) or whenever a new key frame is selected without repeatedly performing S5082-S5085. In one example, since the 3D location of the object is available, the updated distance between the object and the UAV can be conveniently determined by integrating the current 3D location of the UAV and the 3D location of the object (e.g., calculating Euclidean distance between the 3D locations). In another example, since a positional relationship between the object and the UAV at a certain time is known (e.g., the positional relationship at the capturing moment of the last key frame can be described by a first displacement vector), the updated distance between the object and the UAV can be conveniently determined by integrating the known positional relationship and a location change of the UAV between current time and the time point corresponding to the known positional relationship (e.g., calculating an absolute value of a vector obtained by adding the first displacement vector with a second displacement vector describing location change of the UAV itself since the last key frame). In some other embodiments, the system may execute S5082-S5085 again to calculate the updated distance to the object when certain numbers of new key frames are accumulated to form a new key frame sequence.

In some embodiments, the key frames are captured when the target object is motionless. In some embodiments, the key frames are captured when the target object is moving and a background object of the target object is motionless. The 3D location of the background object may be obtained using the disclosed method. Further, based on relative positions between the background object and the target object, the distance to the target object can be obtained based on the tracked motion of the target object and the 3D location of the background object. For example, the background object is a building, and the target object is a car moving towards/away from the building while the UAV is moving and capturing images containing both the building and the car. By implementing the disclosed process (e.g., S5081-S5085), the 3D location of the building and positional relationship between the building and the UAV can be obtained. Further, a 3D positional relationship between the car and the building can be obtained from relative 2D position changes between the building and the car suggested by the captured images, combined with relative depth changes between the building and the car suggested by onboard depth sensor (e.g., a stereo camera, a radar, etc.). By integrating the 3D positional relationship between the building and the UAV and the 3D positional relationship between the car and the building, a 3D positional relationship between the car and the UAV can be obtained, as well as the distance between the car and the UAV.

In some embodiments, calculating the distance between the to-be-measured object and the UAV (S508) may further include accessing data produced in maintaining routine operations of the UAV and using the data for routine operations to calculate the distance between the to-be-measured object and the UAV. When the UAV is operating, various sensor data is recoded in real-time and analyzed for maintaining routine operations of the UAV. The routine operations may include capturing images using the onboard camera and transmitting the captured images to a remote control to be displayed, hovering stably when no movement control is received, automatically avoiding obstacles, responding to control command from a remote control (e.g., adjusting flight altitude, speed, and/or direction based on user input to the remote control, flying towards a location selected by the user on the remote control), and/or providing feedbacks to remote control (e.g., reporting location and flight status, transmitting real-time image). The recorded sensor data may include: data of a gyroscope, data of an accelerometer, rotation degree of a gimbal carrying the main camera, GPS data, colored image data collected by the main camera, grayscale image data collected by stereo vision camera system. An inertial navigation system of the UAV may be used to obtain a current location/position of the UAV for the routine operations. The inertial navigation system may be implemented by an inertial measurement unit (IMU) of the UAV based on gyroscope data and accelerometer data, and/or GPS data. The current location/position of the UAV may also be obtained by a VO circuit that implements a visual odometry mechanism based on grayscale image data collected by a stereo camera of the UAV. Data from the IMU and the VO circuit can be integrated and analyzed to obtain pose information of the UAV including position of the UAV in world coordinate system with enhanced accuracy. In some embodiments, the disclosed distance measurement system may determine whether data needed for calculating the distance is readily accessible from data collected for routine operations of UAV. If a specific type of data is not available, the system may communicate with a corresponding sensor or other component of the UAV to enable data collection and acquire the missing type of data. In some embodiments, the disclosed distance measurement procedure does not need to collect any additional data besides data collected for routine operations of UAV. Further, the disclosed distance measurement procedure can utilize data already processed and produced in maintaining routine operations, such as data produced by the IMU and the VO circuit.

In some embodiments, data produced by the IMU and the VO circuit for routine operations of the UAV may be directly used in the distance measuring process. The data produced for routine operations can be used for selecting key frames (e.g., at S5081) and/or determining initial values of for bundle adjustment (e.g., at S5084) in the distance measuring process.

In some embodiments, data produced for maintaining routine operations of the UAV that can be used for selecting key frames include: a pose of the UAV at a capturing moment of a previous image frame, and IMU data collected since the capturing moment of the previous image frame. In some embodiments, such data can be used in determining an estimated camera pose corresponding to a current image frame and determining whether the current image frame is a key frame accordingly. For example, routine operations include calculating poses of the UAV continuously based on IMU data and VO/GPS data (e.g., by applying a visual inertial odometry algorithm). Accordingly, the pose of the UAV at the capturing moment of the previous image frame is ready to be used. The pose of the UAV corresponding to the current image frame may not be solved or ready right away at the moment of determining whether the current image frame is a key frame. Thus, an estimated camera pose of the main camera corresponding to the current image frame can be obtained according to the pose of the UAV at the capturing moment of the previous image frame and the IMU data corresponding to the capturing moment of the current image frame (e.g., the IMU data collected between the capturing moment of the previous image frame and the capturing moment of the current image frame).

In some embodiments, IMU pre-integration can be implemented for estimating movement/position change of the UAV between capturing moments of a series of image frames based on previous UAV positions and current IMU data. For example, a location of the UAV when capturing a current image frame can be estimated based on a location of the UAV when capturing a previous image frame and IMU pre-integration of data from the inertial navigation system. IMU pre-integration is a process that estimates a location of the UAV at time point B using a location of the UAV at time point A and an accumulation of inertial measurements obtained between time points A and B.

A mathematical description of the IMU pre-integration in discrete form is as follows:

pₖ₊₁=pₖ+vₖΔt+½(R_{wi}(aₘ−bₐ)+g)Δt²

vₖ₊₁=vₖ+(R_{wi}(aₘ−bₐ)+g)Δt

qₖ₊₁=qₖ⊗Δq

Δq=q{(ω−b_{ω})Δt}

(bₐ)ₖ₊₁=(bₐ)ₖ

(b_{ω})ₖ₊₁=(b_{ω})ₖ

where pₖ₊₁ is an estimated 3D location of the UAV when capturing the current image frame, and pₖ is 3D location of the UAV when capturing a previous image frame based on data from routine operations (e.g., calculated based on IMU, the VO circuit, and/or GPS sensor). vₖ₊₁ is a speed of the UAV when capturing the current image frame, and vₖ is a speed of the UAV when capturing the previous image frame. qₖ₊₁ is quaternion of the UAV when capturing the current image frame, and qₖ is quaternion of the UAV when capturing the previous image frame. (bₐ)ₖ₊₁ and (bₐ)ₖ are respective accelerometer bias when capturing the current image frame and the previous image frame. (b_{ω})ₖ₊₁ and (b_{ω})ₖ are respective gyroscope bias when capturing the current image frame and the previous image frame. Δt is a time difference between the moment of capturing the current image frame k+1 and the moment of capturing the previous image frame k. aₘ denotes current readings of the accelerometer, g is the gravitational acceleration, and (denotes current readings of the gyroscope. Δq is rotation estimate between the current image frame and the previous image frame, and q{ } denotes a conversion from Euler angle representation to quaternion representation. R_{wi} denotes rotational relationship between the UAV coordinate system and the world coordinate system, and can be obtained from the quaternion q.

In some embodiments, the current image frame and the previous image frame may be two consecutively captured imaged frames. In the IMU pre-integration process, parameters directly obtained from the sensors include accelerometer reading aₘ and gyroscope reading ω. Remaining parameters can be obtained based on the above mathematical description or any other suitable calculation. Accordingly, a pose of the UAV corresponding to a current image frame can be estimated by the IMU pre-integration of the pose of the UAV corresponding to a previous image frame (e.g., previously solved in routine operations of the UAV using visual inertial odometry) and IMU data corresponding to the current image frame.

In some embodiments, the frequency of capturing consecutive image frames (e.g., 20-30 Hz) is lower than the frequency of recording accelerometer readings and gyroscope readings (e.g., 200-400 Hz). That is, multiple accelerometer readings and gyroscope readings can be obtained between capturing moments of two consecutive image frames. In one embodiment, the IMU pre-integration can be performed based on recording frequency of the accelerometer and gyroscope readings. For example, Δt′ denotes a time difference between two consecutive accelerometer and gyroscope readings, and Δt=nΔt′, n being an integer greater than 1. The IMU pre-integration can be performed at the same frequency as the recording frequency of the accelerometer and gyroscope readings according to Δt′. The estimated 3D location of the UAV when capturing the current image frame can be obtained by outputting every nth pre-integration result at matching moments between image capturing and accelerometer/gyroscope data recording. In one embodiment, the multiple accelerometer/gyroscope readings obtained between capturing moments of two consecutive image frames are filtered to obtain noise-reduced results for being used in the IMU pre-integration.

In some embodiments, using data produced for routine operations of the UAV in distance measuring process (e.g., in key frame selection) may include: using readings of the gyroscope in determining whether the UAV is in a steady movement state. If the UAV is not in a steady movement state, the captured images may not be suitable for use in distance measurement. For example, when the angular speed is less than a preset threshold, i.e., when ∥ω−b_{ω}∥₂<ωₜₕ, ωₜₕ being a threshold angular speed, the UAV can be determined as in a steady movement state, and the image captured at the steady movement state may be used for distance measurement. Further, an image that is not captured at the steady movement state may not be selected as key frame.

In some embodiments, camera pose relationships between capturing moments of two consecutive frames (e.g., the previous image frame and the current image frame) can be estimated according to results from the IMU pre-integration. In some embodiments, when VO algorithm is used on stereo images of the UAV, the stereo camera motion obtained from the VO algorithm can indicate position and motion of the UAV. Further, camera poses of the stereo camera or pose of the UAV obtained from the VO algorithm, the IMU pre-integration data, and/or the GPS data can provide a coarse estimation of camera poses of the main camera. In some embodiments, the estimated camera pose of the main camera is obtained by combining the pose of the UAV and a pose of the gimbal relative to the UAV (e.g., rotation degree of the gimbal, and/or relative attitude between the UAV and the gimbal). For example, the estimated camera pose of the main camera corresponding to a previous image frame can be the combination of the pose of the UAV corresponding to the previous image frame (e.g., from routine operation) and the rotation degree of the gimbal corresponding to the previous image frame. The estimated camera pose of the main camera corresponding to a current image frame can be the combination of the estimated pose of the UAV corresponding to the current image frame (e.g., from IMU pre-integration) and the rotation degree of the gimbal corresponding to the current image frame.

In some embodiments, using data produced for routine operations of the UAV in distance measuring process (e.g., in key frame selection) may include: using camera pose relationships between two consecutive frames in obtaining a camera pose relationship between a key frame and an image frame captured after the key frame. Provided that a current key frame is determined, extracting a next key frame may include: determining whether the camera pose relationship between the key frame and the image frame captured after the key frame satisfies a preset condition; and selecting the image frame as the next key frame in response to the camera pose relationship satisfying the preset condition.

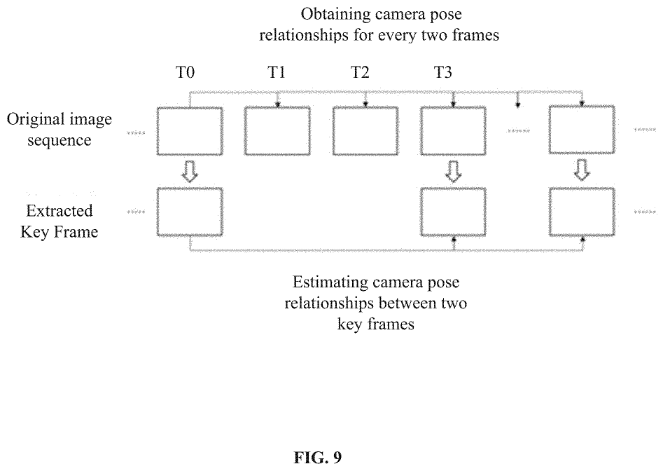

FIG. 9 illustrates a key frame extraction process according to an exemplary embodiment of the present disclosure. As shown in FIG. 9, the original image sequence includes a plurality of image frames captured at fixed frequency (e.g., 30 Hz). VO calculation and/or IMU pre-integration is performed for every two consecutive frames to obtain camera pose relationship between two consecutive image capturing moments. The camera pose relationship between a key frame and any image frame captured after the key frame can be obtaining by repeatedly accumulating camera pose relationships between two consecutive image capturing moments i.e., accumulating starting from camera pose relationship of the pair of the key frame and its earliest following frame, until camera pose relationship of the pair of the to-be analyzed image frame and its latest preceding frame. For example, as shown in FIG. 9, the current key frame is captured at moment T0. The camera pose relationship between moment T0 and T1 can be obtained from the VO calculation and/or MU pre-integration and analyzed to determine whether the preset condition is satisfied. When the preset condition is not satisfied for the camera pose relationship between moments T0 and T1, the key frame selection process moves on to determine whether a camera pose relationship between moments T0 and T2 satisfies the preset condition. The camera pose relationship between moments T0 and T2 can be obtained by combining the camera pose relationship between moments T0 and T1 and a camera pose relationship between moment T1 and T2. When the preset condition is satisfied for the camera pose relationship between moments T0 and T3, the key frame selection process determines the image frame captured at moment T3 as the next key frame.

In some embodiments, the preset condition corresponding to the camera pose relationship comprises at least one of a rotation threshold or a displacement threshold. In one embodiment, when displacement between an image frame and the current key frame is big enough and/or rotation between the image frame and the current key frame is small enough, the image frame is determined as the next key frame. In other words, the camera pose relationship comprises at least one of a rotation change from a moment of capturing the key frame to a moment of capturing the image frame or a position change of the camera from the moment of capturing the key frame to the moment of capturing the image frame. Determining whether the camera pose relationship satisfies the preset condition includes at least one of: determining that the camera pose relationship satisfies the preset condition in response to the rotation change being less than the rotation threshold; and determining that the camera pose relationship satisfies the preset condition in response to the rotation change being less than the rotation threshold and the position change being greater than the displacement threshold. In some embodiments, when the position change is less than or equal to the displacement threshold (e.g., indicating the position change is not significant enough to be processed), the image frame may be disqualified to be selected as a key frame and the process moves on to analyze the next image frame. In some embodiments, when the rotation change is greater than or equal to the rotation threshold (e.g., indicating the image was not taken in a steady environment and might impair accuracy of the result), the image frame may be discarded, and the process moves on to analyze the next image frame.

Mathematically, the rotation change R can be described in Euler angles: R=[ϕ,θ,φ]^{T}. The preset condition may include satisfying the following inequality: ∥R∥₂=\sqrt{ϕ²+θ²+φ²}<αₜₕ, where αₜₕ is the rotation threshold. The position/translational change t can be described by t=[tₓ, t_{y}, t_{z}]^{T}. The preset condition may include satisfying the following inequality: ∥t∥₂=\sqrt{tₓ²+t_{y}²+t_{z}²}>dₜₕ, where dₜₕ is the displacement threshold.

In some embodiments, using data for routine operations of the UAV in distance measuring process (e.g., in assigning initial values for bundle adjustment algorithm) may include: integrating data from the IMU, the VO circuit and the GPS sensor to obtain pose information of the UAV corresponding to capturing moments of the key frames. The estimated camera pose information of the main camera can be obtained by, for example, a linear superposition of a camera pose of the stereo camera (i.e., pose information of the UAV) and a positional relationship between the main camera and the UAV (i.e., position/rotation of the gimbal relative to the UAV). Since BA algorithm is an optimization problem, assigning a random initial value may result in a local optimum instead of a global optimum. Using the estimated camera pose information from IMU and VO data for the initial values of BA algorithm in S5084, numbers of iterations can be reduced, the convergence time of the algorithm can speed up, and error probability is reduced. Further, in some embodiments, GPS data may also be used in the BA algorithm as initial values and constraints to obtain an accurate result.

In some embodiments, data for routine operations of the UAV used in distance measuring process are collected and produced by the UAV (e.g., at S504, S506, S5081, and when obtaining initial values at S5084), and transmitted to the remote control, and object identification and distance calculation and presentation is performed on the remote control (e.g., at S502, S5082-S5085, S510). In some embodiments, only obtaining user input in identifying an object and presenting the calculated distance are performed on the remote control, and remaining steps are all performed by the UAV.

It can be understood that the mathematical procedures for calculating camera pose information described herein is not the only procedure. Other suitable procedures/algorithms may substitute certain the disclosed steps.

The present disclosure provides a method and a system for measuring distance using unmanned aerial vehicle (UAV) and a UAV capable of measuring distance. Different from traditional ranging method, the disclosed method provides a graphical user interface that allows a user to select an object of interest in an image captured by a camera of the UAV and provides measured distance in almost real-time (e.g., less than 500 milliseconds). Further, the disclosed method can directly utilize inertial navigation data from the UAV's own IMU and data from the VO circuit produced for routine operations in distance measuring, which further saves computation resources and processing time. The disclosed method is intuitive and convenient, and can provide reliable measurement result with fast calculation speed.

The processes shown in the figures associated with the method embodiments can be executed or performed in any suitable order or sequence, which is not limited to the order and sequence shown in the figures and described above. For example, two consecutive processes may be executed substantially simultaneously where appropriate or in parallel to reduce latency and processing time, or be executed in an order reversed to that shown in the figures, depending on the functionality involved.

Further, the components in the figures associated with the device embodiments can be coupled in a manner different from that shown in the figures as needed. Some components may be omitted and additional components may be added.

Other embodiments of the disclosure will be apparent to those skilled in the art from consideration of the specification and practice of the embodiments disclosed herein. It is intended that the specification and examples be considered as exemplary only and not to limit the scope of the disclosure, with a true scope and spirit of the invention being indicated by the following claims.

What is claimed is:

1. A method for measuring distance using an unmanned aerial vehicle (UAV), comprising:
identifying a target object to be measured;
receiving a plurality of images captured by a camera of the UAV when the UAV is moving and the camera is tracking the target object;
collecting movement information of the UAV corresponding to capturing moments of the plurality of images; and
calculating a distance between the target object and the UAV based on the movement information and the plurality of images.

2. The method of claim 1, wherein identifying the target object comprises:
receiving an initial image containing the target object captured by the camera of the UAV; and
identifying the target object in the initial image.

3. The method of claim 2, wherein identifying the target object further comprises:
displaying the initial image on a graphical user interface;
obtaining a user selection of a target area in the initial image; and
obtaining the target object based on the target area.

4. The method of claim 3, wherein the user selection comprises a single tap at a center of the target area, a double tap at the center of the target area, or a dragging operation having a starting point and an ending point that define a bounding box of the target area.

5. The method of claim 3, wherein identifying the target object comprises:
obtaining super-pixels of the initial image by clustering pixels of the initial image based on image features of the pixels;
obtaining one or more super-pixels located in the target area, including:
obtaining a super-pixel partially located in the target area;
determining a percentage by dividing a number of pixels in the super-pixel that are located inside the target area by a total number of pixels in the super-pixel; and
determining that the super-pixel is located in the target area in response to the percentage being greater than a preset threshold; and
identifying an image area formed by the one or more super-pixels as an area representing the target object.

6. The method of claim 1, further comprising:
after identifying the target object, determining whether the target object is a moving object using a convolutional neural network (CNN);
wherein a warning message indicating a compromised measurement accuracy is presented in response to the target object being determined to be a moving object.

7. The method of claim 1, further comprising:
after identifying the target object, extracting target feature points corresponding to the target object; and
determining whether a quantity of the target feature points is less than a preset quantity threshold;
wherein a warning message indicating a compromised measurement accuracy is presented in response to the quantity of the target feature points being less than the preset quantity threshold.

8. The method of claim 1, further comprising:
determining an initial radius, the initial radius being an estimated distance between the target object and the UAV;
determining an initial speed based on the initial radius; and
moving the UAV at the initial speed along a curved path having the initial radius around the target object.

9. The method of claim 8, further comprising:
determining a location of the target object in one of the captured plurality of images; and
adjusting at least one of a pose of a gimbal carrying the camera or a speed of the UAV based on the location of the target object.

10. The method of claim 1, further comprising:
obtaining readings from a gyroscope of the UAV when the UAV is moving and the camera is tracking the target object;
determining whether the UAV is in a steady movement state based on the readings of the gyroscope and the accelerometer; and
using the plurality of images captured when the UAV is in the steady movement state to calculate the distance between the target object and the UAV.

11. The method of claim 1, further comprising:
obtaining a plurality of estimated camera poses based on the movement information corresponding to the capturing moments of the plurality of images, each of the plurality of images corresponding to one of the estimated camera poses.

12. The method of claim 11, further comprising:
obtaining a camera pose relationship between a key frame and an image frame captured after the key frame, the key frame being one of the plurality of images;
determining whether the camera pose relationship satisfies a preset condition; and
selecting the image frame as one of the plurality of images in response to the camera pose relationship satisfying the preset condition;
wherein collecting the movement information of the UAV comprises collecting, by an inertial measurement unit (IMU) of the UAV, pose information of the UAV, the pose information comprising an orientation and a position of the UAV.

13. The method of claim 12, wherein the camera pose relationship is a first camera pose relationship and the image frame is a first image frame;
the method further comprising:
obtaining, in response to the first camera pose relationship not satisfying the preset condition, a second camera pose relationship between the key frame and a second image frame captured after the first image frame;
determining whether the second camera pose relationship satisfies the preset condition; and
selecting the second image frame as one of the plurality of images in response to the second camera pose relationship satisfying the preset condition.

14. The method of claim 12, further comprising:
after selecting the image frame as one of the plurality of images, using the image frame as the key frame and determining whether to select another image frame captured after the image frame as one of the plurality of images based on whether a camera pose relationship between the image frame and the other image frame satisfies the preset condition.

15. The method of claim 12, wherein:
the preset condition comprises at least one of a rotation threshold or a displacement threshold;
the camera pose relationship comprises at least one of a rotation change from a moment of capturing the key frame to a moment of capturing the image frame or a position change of the camera from the moment of capturing the key frame to the moment of capturing the image frame; and
determining whether the camera pose relationship satisfies the preset condition comprises at least one of:
determining that the camera pose relationship satisfies the preset condition in response to the rotation change being less than the rotation threshold; or
determining that the camera pose relationship satisfies the preset condition in response to the rotation change being less than the rotation threshold and the position change being greater than the displacement threshold.

16. The method of claim 12, wherein obtaining the plurality of estimated camera poses comprises:
obtaining a current estimated camera pose corresponding to a current image frame based on a previous estimated camera pose corresponding to a previous image frame and the movement information corresponding to the current image frame, the current image frame and the previous image frame being captured when the UAV is moving.

17. The method of claim 11, further comprising:
extracting a plurality of feature points from each of the plurality of images, the plurality of feature points including a center point of the target object;
tracking two-dimensional (2D) locations of the plurality of feature points in the plurality of images, including:
tracking displacements of the plurality of feature points between each two consecutive ones of the plurality of images;
obtaining optical flow vectors of the plurality of feature points according to the tracked displacements; and
tracking 2D locations of the center point of the target object in the plurality of images based on the optical flow vectors of a plurality of target feature points identified from the plurality of feature points, the target feature points being within an area of the target object;
obtaining a three-dimensional (3D) location of the center point based on the 2D locations of the center point in the plurality of images and the plurality of estimated camera poses corresponding to the capturing moments of the plurality of images;
obtaining refined camera pose information based on the 2D locations of the plurality of feature points in the plurality of images; and
calculating the distance between the target object and the UAV according to the 3D location of the center point and a 3D location of the camera indicated by the refined camera pose information.

18. The method of claim 1, further comprising:
after the distance is calculated, displaying the distance on a graphical user interface.

19. The method of claim 18, further comprising:
displaying the plurality of images in real-time on the graphical user interface; and
marking the distance on an image currently displayed on the graphical user interface.

20. The method of claim 19, further comprising:
updating the distance between the target object and the UAV in real-time based on additional images captured by the camera and movement information corresponding to capturing moments of the additional images.
